(19) United States
(12) Patent Application Publication
(10) Pub. No.: US 2009/0006961 A1
(43) Pub. Date: Jan. 1, 2009

(54) INFORMATION PROCESSING APPARATUS AND VIDEO AND AUDIO INFORMATION PROTECTING METHOD

(75) Inventor: Hiroshi Nakajima, Nishitokyo-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/144,868

(22) Filed: Jun. 24, 2008

(30) Foreign Application Priority Data
Jun. 29, 2007 (JP) 2007-173473

(51) Int. Cl. G06F 3/14; H04L 9/06

(52) U.S. Cl. 715/716; 380/29

(57) ABSTRACT

According to one embodiment, an information processing apparatus which conducts display of video and output of audio from video and audio information including video data and audio data, includes a processor which can execute various softwares, a memory which stores data therein, and a decoder which is configured from a software configured from a plurality of modules and executed by the processor in order to perform a processing for conducting display of video and output of audio, where the decoder causes the processor to perform a processing for partially encrypting data transferred between the modules via the memory and a processing for decoding the data transferred between the modules via the memory.

### CROSS-REFERENCE TO RELATED APPLICATIONS

This application is based upon and claims the benefit of priority from Japanese Patent Application No. 2007-173473, filed Jun. 29, 2007, the entire contents of which are incorporated herein by reference.

### BACKGROUND

1. Field

One embodiment of the invention relates to an information processing apparatus for protecting content and a video and audio information protecting method.

2. Description of the Related Art

In order to receive digital terrestrial broadcasting broadcast in Japan on an open architecture equipment called computer, a mechanism of copyright protection is also required for satisfying operational rules of the Association of Radio Industries and Business (ARIB).

According to the operational rules of ARIB, a user accessible internal bus such as a Peripheral Component Interconnect (PCI) Express bus or central processing unit (CPU) with a memory must be put in a secure environment in order to receive digital terrestrial broadcasting by a computer which is an open architecture.

The Advanced Access Content System Licensing Association (AACS LA) specification for content protection of next-generation DVDs such as HD DVD ® and Blu-ray may require that an internal bus be put in a secure environment like ARIB in the future.

Japanese Patent No. 3603415 discloses a system which analyzes coded digital data to take out playback order control information and encrypts the taken-out portion to protect the same.

In the abovementioned system, many processing steps must be performed until encryption is completed, so that hardware cost is increased in order to conduct encryption over all portions.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an appearance of a computer according to an embodiment of the present invention;

FIG. 2 is an exemplary block diagram showing a system configuration of the computer shown in FIG. 1;

FIG. 3 is an exemplary diagram showing a structure of a TS packet configuring broadcast program data received by the computer in FIG. 1;

FIG. 4 is an exemplary diagram for explaining a descramble processing of broadcasting content performed by the computer in FIG. 1;

FIG. 5 is an exemplary block diagram showing a configuration of a copyright protection LSI provided in the computer shown in FIG. 1;

FIG. 6 is an exemplary diagram for explaining a procedure of a series of processing from reception of digital terrestrial TV broadcasting to playback thereof performed by the computer shown in FIG. 1;

FIG. 7A is an exemplary diagram showing an image displayed on an LCD;

FIG. 7B is an exemplary diagram showing an image displayed based upon captured data;

FIG. 8 is an exemplary diagram for explaining a processing for partially encrypting data; and

FIG. 9 is an exemplary diagram for explaining a processing for decoding data.

### DETAILED DESCRIPTION

Various embodiments according to the invention will be described hereinafter with reference to the accompanying drawings. In general, according to one embodiment of the invention, an information processing apparatus which conducts display of video and output of audio from video and audio information including video data and audio data, comprises a processor configure to execute various softwares, a memory configure to stores data therein, and a decoder configured from a software configured from a plurality of modules and executed by the processor in order to perform a processing for conducting display of video and output of audio, where the decoder causes the processor to perform a processing for partially encrypting data transferred between the modules via the memory and a processing for decoding the data transferred between the modules via the memory.

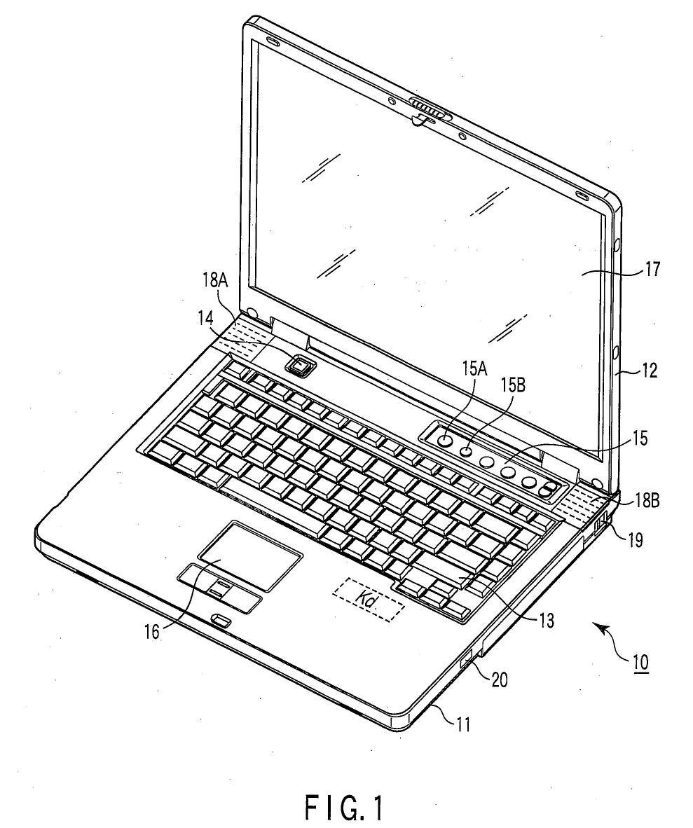

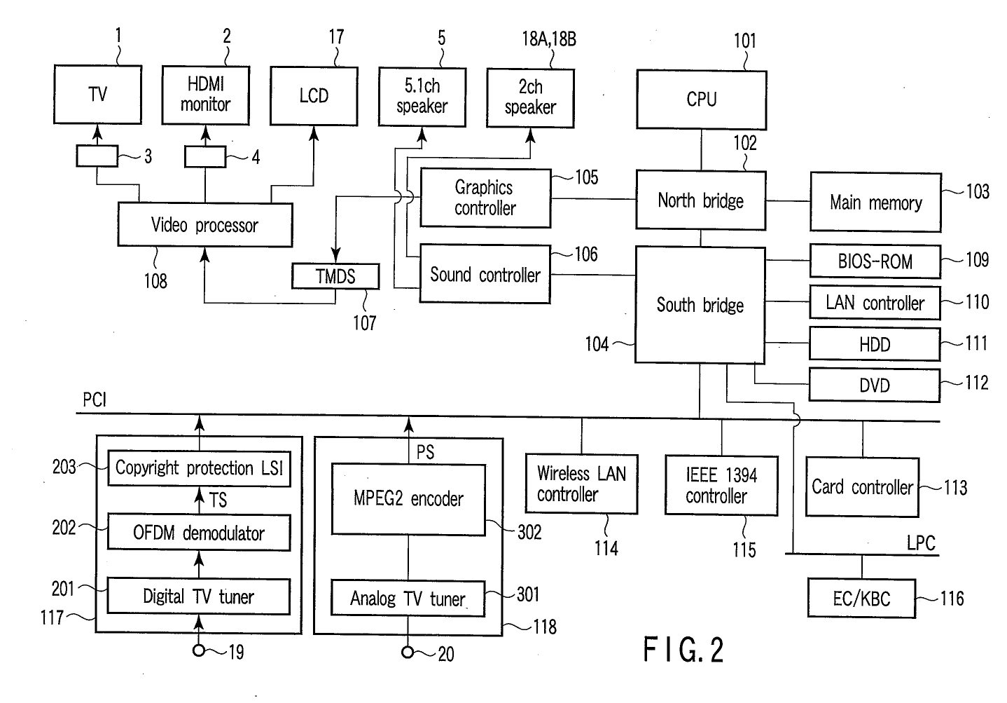

Referring to FIGS. 1 to 2, first, a configuration of an information processing apparatus according to an embodiment of the present invention will be explained. The information processing apparatus is realized as, for example, a notebook type personal computer 10.

FIG. 1 is a perspective view of the notebook type personal computer 10 where a display unit has been opened. The computer 10 comprises a computer main body 11 and a display unit 12. The display unit 12 is incorporated with a display device comprising a TFT-LCD (Thin Film Transistor Liquid Crystal Display) 17, and a display screen of the LCD 17 is positioned at an approximately central portion of the display unit 12.

The display unit 12 is attached to the computer main body 11 so as to be rotatable between an opened position and a closed position thereto. The computer main body 11 has a thin box-like casing, and a keyboard 13, a power button 14 for conducting power-on/power-off of the computer 10, an input operation panel 15, a touch pad 16, speakers 18A and 18B, and the like are disposed on an upper face of the computer main body 11.

The input operation panel 15 is an input device for inputting an event corresponding to a pushed button, and it is provided with a plurality of buttons for activating a plurality of functions. A group of these buttons includes a TV activation button 15A, and a DVD/CD activation button 15B. The TV activation button 15A is a button for activating a TV function for conducting playback and recording of TV broadcast program data. When the TV activation button 15A is pushed down by a user, a TV application program for conducting the TV function is activated.

When the power button 14 is pushed down by the user, an operating system is activated. On the other hand, the TV activation button 15A is pushed down by the user, the operating system is activated so that the TV application program is automatically executed. The user can conduct TV viewing/recording instantaneously by only pushing the TV activation button 15A.

The computer 10 can receive and reproduce both TV broadcastings of digital terrestrial TV broadcasting and analog terrestrial TV broadcasting. An antenna terminal 19 for digital terrestrial TV broadcasting and an antenna terminal 20 for analog terrestrial TV broadcasting are provided on a right side face of the computer main body 11. In the digital terrestrial TV broadcasting, content of broadcast program data is scrambled (encrypted). In order to handle the scrambled broadcast program data, a storage section in which device identification information has been stored in advance is incorporated into the computer main body 11. The storage section is included in an exclusive LSI for copyright protection of digital broadcast program data. The device identification information is used as a device key (Kd) required to descramble the scrambled broadcast program data. The device identification information is ID for identifying the computer 10, and it comprises information for identifying a model of the computer 10 or information for identifying a manufacturer of the computer 10. Specifically, the device identification information comprises a pair of model ID for identifying a model of the computer 10 and a device key Kd corresponding to the model ID or a pair of a manufacturer ID for identifying a manufacturer of the computer 10 and a device key Kd corresponding to a manufacturer ID. Hereinafter, the model ID and the manufacture ID are called device ID.

In the digital terrestrial TV broadcasting, a stream obtained by multiplexing a plurality of broadcast program data items is broadcast by broadcast waves. The stream includes program content encrypted (scrambled) by a scramble key (Ks), common information (ECM: Entitlement Control Message) obtained by encrypting Ks with a work key (Kw: second encyption key), and several individual information items (EMM: Entitlement Management Message) obtained by encrypting Kw with device identification information items (device keys (Kd) in a simulating manner) corresponding to individual allowed receivers. Each EMM includes a corresponding device ID.

The computer 10 uses ECM and EMM included in broadcast program data and a device key (Kd) stored in a B-CAS (BS Conditional Access Systems Co., Ltd.) card to produce a scramble key (Ks) for descrambling (decoding) scrambled program content. In this case, the device key (Kd) is used for decoding EMM including the device ID of the computer 10 to produce Kw. The produced Kw is used for decoding the ECM to produce Ks.

The DVD/CD activation button 15B is a button for reproducing video content recorded on a DVD or a CD. When the DVD/CD activation button 15B is pushed down by the user, a video playback application program for reproducing video content is activated. When the DVD/CD activation button 15B is pushed down by the user, the operating system is activated so that the video playback application program is automatically executed.

Next, a system configuration of the computer 10 will be explained with reference to FIG. 2.

As shown in FIG. 2, the computer 10 is provided with a CPU 101, a north bridge 102, a main memory 103, a south bridge 104, a graphics controller 105, a sound controller 106, a TMDS (Transition Minimized Differential Signaling) circuit 107, a video processor 108, a BIOS-ROM 109, a LAN controller 110, a hard disk drive (HDD) 111, a DVD drive 112, a card controller 113, a wireless LAN controller 114, an IEEE 1394 controller 115, an embedded controller/keyboard controller IC (EC/KBC) 116, a digital TV broadcasting reception processing section 117, and an analog TV broadcasting reception processing section 118.

The CPU 101 is a processor for controlling an operation of the computer 10 and it executes a main operating system loaded from the hard disk drive (HDD) 111 to the main memory 103 and various application programs such as a TV application program. The CPU 101 also executes a system BIOS (Basic Input Output System) stored in the BIOS-ROM 109. The system BIOS is a program for conducting hardware control.

The north bridge 102 is a bridge device connecting a local bus of the CPU 101 and the south bridge 104. A memory controller for performing access control of the main memory 103 is incorporated in the north bridge 102. The north bridge 102 also has a function for performing communication with the graphics controller 105 via an AGP (Accelerated Graphics port) bus, a PCI express standard serial bus or the like.

The graphics controller 105 is a display controller for controlling the LCD 17 used as a display monitor for the computer 10. Video data produced by the graphics controller 105 is fed to the video processor 108 via the TMDS circuit 107. The video processor 108 performs video processing (graphics quality adjustment processing) for achieving high-quality graphics of video data from the graphics controller 105. The video data whose high-quality graphics has been achieved by the video processor 108 is fed to the LCD 17. The video data whose high-quality graphics has been achieved by the video processor 108 can also be fed to an external TV 1 and an external HDMI monitor via interfaces 3 and 4 provided in the computer main body 11.

The south bridge 104 controls respective devices on an LPS (Low Pin Count) and respective devices on a PCI (Peripheral Component Interconnect) bus. The south bridge 104 is incorporated with an IDE (Integrated Drive Electronics) controller for controlling the HDD 111 and the DVD drive 112. Further, the south bridge 104 also has a function of conducting communication with the sound controller 106.

The sound controller 106 is an audio source device, and it outputs audio data to be reproduced to the speakers 18A and 18B or an external 5.1 channel speaker system.

The card controller 113 controls such a card as a PC card or an SD (Secure digital) card. The wireless LAN controller 114 is a radio communication device for performing radio communication of, for example, IEEE 802.11 standard. The IEEE 1394 controller 115 performs communication with an external device via a serial bus of IEEE 1394 standard. The embedded controller/keyboard controller IC (EC/KBC) 116 is a one chip microcomputer integrated with an embedded controller for power management and a keyboard controller for controlling the keyboard (KB) 13 and the touch pad 16. The embedded controller/keyboard controller IC (EC/KBC) 116 has a function of conducting power-on/power-off of the computer 10 according to operation of the power button 14 conducted by a user. Further, the embedded controller/keyboard controller IC (EC/KBC) 116 can perform power-on of the computer 10 according to operation of the TV activation button 15A or the DVD/CD activation button 15B performed by a user.

The digital terrestrial TV broadcasting reception processing section 117 is a device for receiving a digital broadcast program such as digital terrestrial TV broadcasting, and it is connected to the antenna terminal 19. As illustrated, the digital terrestrial TV broadcasting reception processing section 117 is provided with a digital TV tuner 201, an OFDM (Orthogonal Frequency Division Multiplexing) demodulator 202, and a copyright protection LSI 203. The digital TV tuner 201 and the OFDM demodulator 202 function as a tuner module for receiving broadcast program data of digital terrestrial TV broadcasting. In the digital terrestrial TV broadcasting, a MPEG 2 is utilized as a compression coding compression system to respective broadcast program data items (video, audio). As a video format, an SD (Standard Definition) of a standard resolution and HD (High Definition) of a high resolution can be used.

The tuner module comprising the digital TV tuner 201 and the OFDM demodulator 202 receives a broadcasting signal of a specific channel from TV broadcasting signals inputted from the antenna terminal 19 to take a transport stream (TS) from the received TV broadcasting signal. The transport stream is a stream obtained by multiplexing a plurality of broadcast program data items which have been compression-coded. In the digital terrestrial TV broadcasting, a plurality of programs is multiplexed for each channel (physical channel).

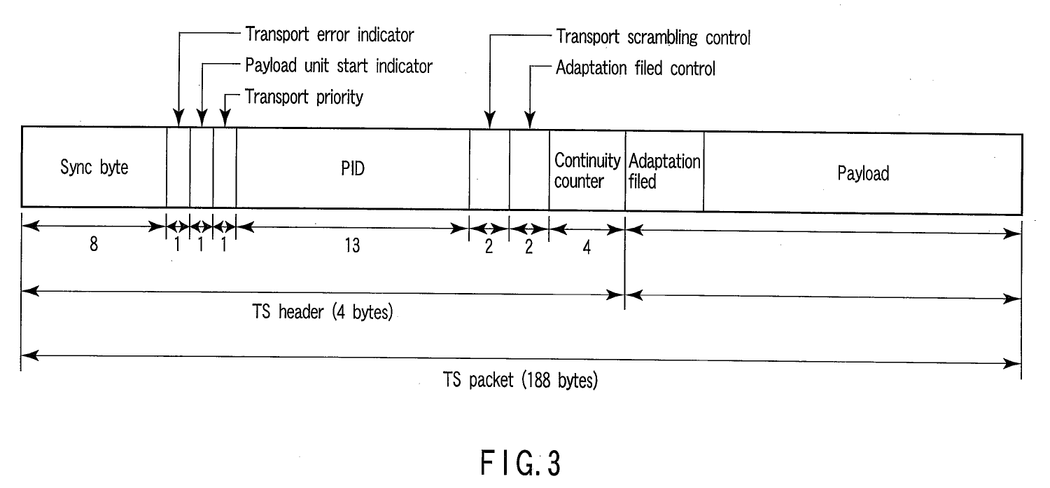

EMM, ECM, and the like as well as broadcast content scrambled by the scramble key (Ks) are included in the transport stream. The transport stream comprises a group of a plurality of successive TS packets. As shown in FIG. 3, each TS packet is a fixed length packet with 188 bytes. The TS packet comprises a header and a payload. A size of the header is a fixed length of 4 bytes. The header includes a packet ID (PID) with 13 byte length. The PID is a packet identifier for identifying a corresponding TS packet. The PID is used for identifying information contained in a payload of a corresponding TS packet. Specifically, the PID is used for identification of a program, identification of a content type (audio/video), identification of EMM/ECM, identification of control information such as a program table. Each TS packet of a TS packet group belonging to the same broadcast program has a PID designated by a PID table to the broadcast program.

The copyright protection LSI 203 is an exclusive LSI for realizing copyright protection (RMP: Rights Management and Protection) of broadcast content. A device ID and a device key Kd corresponding to the computer 10 are stored in the copyright protection LSI 203 in advance. The copyright protection LSI 203 produces a scramble key (Ks) by using ECM and EMM included in the transport stream and the device key (Kd). The copyright protection LSI 203 descrambles (decodes) broadcasting content by the scramble key (Ks) to cancel an encryption. The copyright protection LSI 203 has a PID filtering function extracting a TS packet group including a PID corresponding to a targeted broadcast program from the descrambled transport stream. Only a TS packet group corresponding to a broadcast program to be received/recorded can be fed to a TV application program by the PID filtering function. Thereby, since it is unnecessary to perform a PID filtering processing on the side of the TV application program, load of the TV application program can be reduced. An amount of data flowing in the PCI bus can be largely reduced by performing the PID filtering processing by the copyright protection LSI 203.

The copyright protection LSI 203 has a function of encrypting the TS packet group extracted by the PID filtering function again. The encryption is performed by using an encryption key owned by the copyright protection LSI 203 and the TV application program as a common key. The encryption key is a key different from the scramble key. An encrypted program content can be transferred to the main memory 103 via the PCI bus by the encryption. Thereby, even if program content is illegally taken out via the PCI bus, the taken-out program content can be prevented from being played back.

The analog TV broadcasting reception processing section 118 is a device for receiving an analog broadcast program such as analog terrestrial TV broadcasting, and it is connected to the antenna terminal 20. As illustrated, the analog TV broadcasting reception processing section 118 includes an analog TV tuner 301 and a MPEG2 encoder 302. The analog TV tuner 301 is a tuner module receiving an analog broadcast program and it receives a broadcast signal of a specified channel from TV broadcast signals inputted from the antenna terminal 20. The broadcast program data received by the analog TV tuner 301 is fed to the MPEG2 encoder 302. The MPEG2 encoder 302 compression-codes broadcast program data according to a compression coding system of MPEG2 standard to produce a program stream (PS) obtained by multiplexing compression-coded video data and compression-coded audio data.

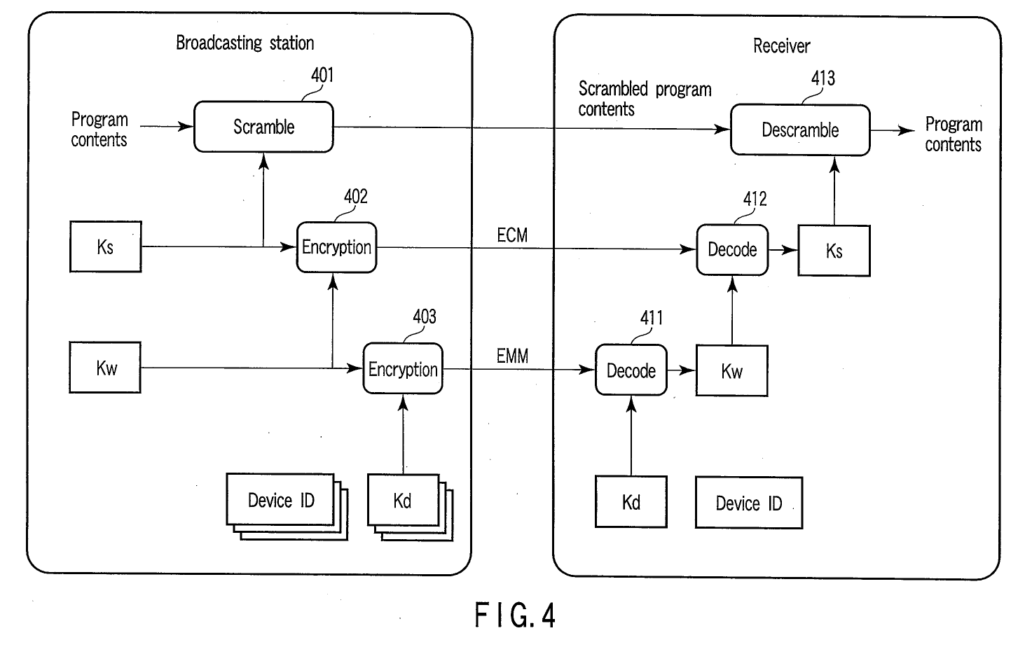

Next, a mechanism of scramble/descramble of broadcast content will be explained with reference to FIG. 4.

In a broadcasting station, a scramble processing section 401, and encryption sections 402 and 403 are provided. In the broadcasting station, a device ID and a device key Kd are managed for each model of an allowed receiver or each manufacturer. The scramble processing section 401 encrypts (scrambles) broadcast program data (program content) with a scramble key Ks. The encryption section 402 encrypts the scramble key Ks with the work key Kw to produce ECM containing the encrypted scramble key Ks. The encryption section 403 encrypts a work key Kw with a plurality of device keys Kd corresponding to a plurality of device IDs, respectively, to produce a plurality of EMMs including the plurality of encrypted work keys Kw, respectively. In this case, each EMM is added with a corresponding device ID. Encryption of the scramble key Ks and encryption of the work key Kw are performed, for example, using AES (Advanced Encryption Standard).

The copyright protection LSI 203 of the computer 10 includes an EMM decoding section 411, an ECM decoding section 412, and a descrambling section 413. The EMM decoding section 411 decodes EMM using the device key Kd stored in the copyright protection LSI 203 to produce a work key Kw. In this case, the EMM decoding section 411 identifies EMM corresponding to the device ID of the computer 10 from a plurality of EMMs to decode the identified EMM using the device key Kd. The ECM decoding section 412 decodes ECM using the produced work key Kw to produce a scramble key Ks. The descrambling section 413 decodes (descrambles) the program content using the produced scramble key Ks.

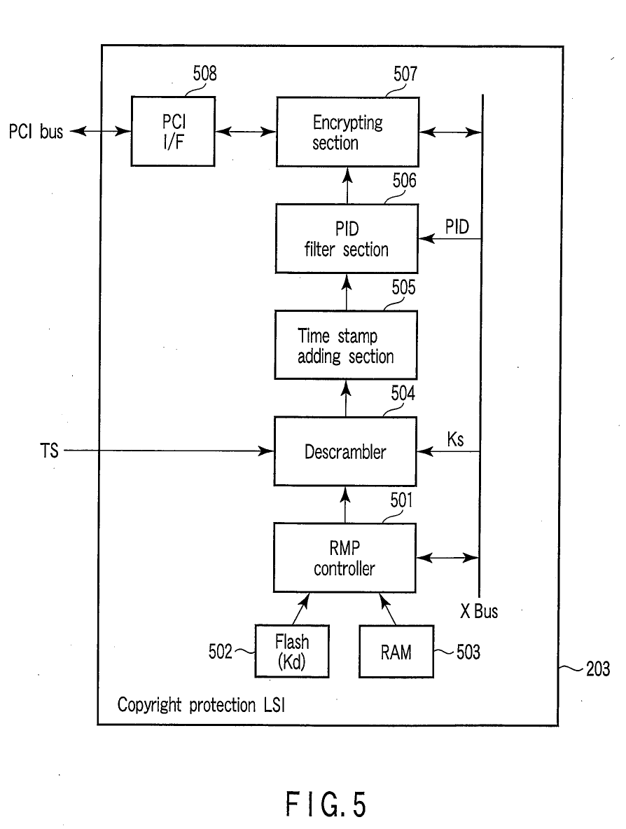

Next, an example of a specific configuration of the copyright protection LSI 203 will be explained with reference to FIG. 5.

As illustrated, the copyright protection LSI 203 comprises a RMP controller 501, a flash EEPROM 502, a RAM 503, a descrambler 504, a time stamp adding section 505, a PID filter section 506, an encryption section 507, and a PCI interface section 508.

The RMP controller 501 is a microcomputer for controlling an operation of the copyright protection LSI 203, and it performs a processing for producing a scramble key Ks. The flash EEPROM 502 is a nonvolatile memory storing a device key Kd together with a device ID therein. The RAM 503 is used as a work memory for the RMP controller 501.

The descrambler 504 descrambles each scrambled transport stream (TS) packet using a scramble key Ks produced by the RMP controller 501. The descrambled TS packet is fed to the time stamp adding section 505. The time stamp adding section 505 adds a time stamp with 4 byte length to a head of the descrambled TS packet with 188 byte length to produce a packet with 192 byte length. The time stamp shows a temporal order between TS packets. The TS packet is converted to a packet with 192 byte length attached with a time stamp by the time stamp adding section 505 so that an encryption processing by the encryption section 507 described later can be performed efficiently.

The PID filter section 506 is a filter circuit which extracts only a TS packet group required for playback of a program to be received by monitoring PID of the TS packet. That is, the PID filter section 506 extracts a TS packet group corresponding to broadcast program data to be received from TS packet groups contained in a transport stream based upon respective PIDs of the TS packet groups included in the descrambled transport stream. The program to be received is indicated by the CPU 101. Each packet extracted by the PID filter section 506 is fed to the encryption section 507.

The encryption section 507 performs an encryption processing for each packet with 192 byte length. The encryption is performed using the same AES system as the encryption of ECM or EMM. The encryption section 507 encrypts a packet with 192 byte length for each block of 128 bit length with the encyption key of a block size 128 bit. That is, a packet with 192 byte length is divided to twelve blocks, each block having 128 bit length, and it is encrypted for each block. Each TS packet with a time stamp encrypted is fed to the PCI interface section 508.

An operation circuit of the encryption section 507 corresponding to the AES system is also utilized for operation for decoding ECM or EMM. That is, the RMP controller 501 receives EMM from the PID filter section 506. The RMP controller 501 inputs the EMM and the device key Kd into the encryption section 507 to cause the encryption section 507 to conduct a decoding processing of the EMM. Thereby, the RMP controller 501 can acquire the work key Kw from the encryption section 507. The RMP controller 501 receives ECM from the PID filter section 506. The RMP controller 501 inputs the ECM and the work key Kw into the encryption section 507 to cause the encryption section 507 to conduct a decoding processing of the ECM. Thereby, the RMP controller 501 can acquire the scramble key Ks from the encryption section 507.

Thus, the RMP controller 501 performs a processing for decoding the EMM and the ECM using the encryption section 507. Thereby, it is unnecessary to provide an operation circuit for the AES cipher in the RMP controller 501, so that a circuit can be simplified.

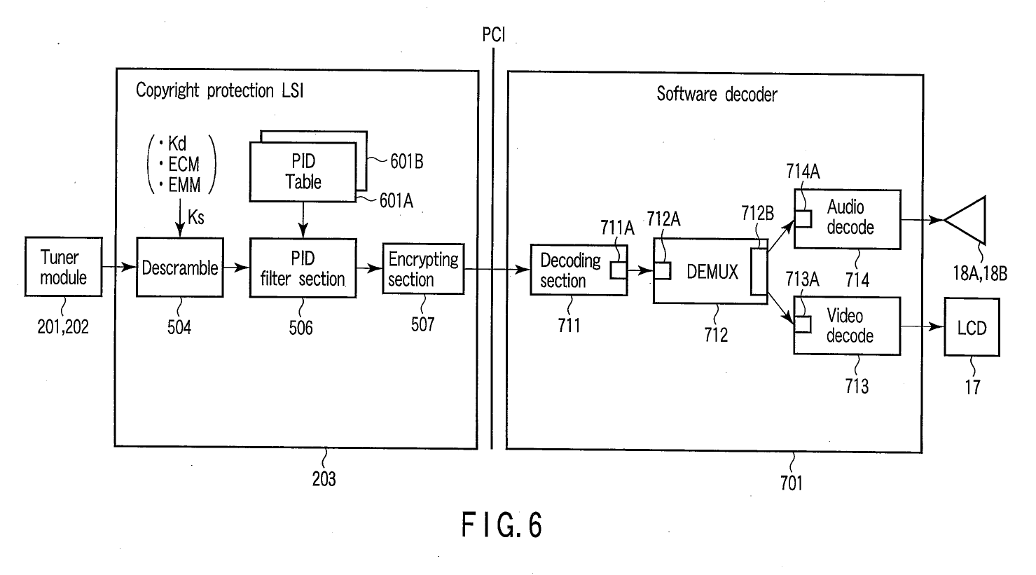

Next, a procedure of a series of processings from reception of digital terrestrial TV broadcasting to playback thereof will be explained with reference to FIG. 6.

The tuner module comprising the digital TV tuner 201 and the OFDM demodulator 202 receives broadcast program data of digital terrestrial TV broadcasting. As described above, the received broadcast program data comprises the scrambled transport stream. The transport stream is fed to the copyright protection LSI 203.

In the copyright protection LSI 203, the transport stream is descrambled by the descrambler 504. As described above, the descramble is performed using the ECM, the EMM, and the scramble key Ks produced from the device key Kd. Each TS packet descrambled is fed to the PID filter section 506. The PID filter section 506 has a PID table having 48 entries and it determines whether or not each TS packet from the descrambler 504 is a TS packet to be extracted referring to the PID table.

The PID table comprises a PID table 601A holding a plurality of prescribed PID values and a PID table 601B holding a plurality of designated PID values. The prescribed PID value is a PID value for identifying a TS packet including various control information items prescribed by a rule of the digital terrestrial TV broadcasting. The PID table 601A holds 16 prescribed PID values. The designated PID value is a PID value for identifying a TS packet regarding a broadcast program to be received, and it is set in the PID table 601B by the RMP controller 501.

The PID filter section 506 extracts a TS packet group including a PID value coinciding with any TS packet in the PID group set in the PID tables 601A and 601B from the descrambled TS packet group referring to the PID tables 601A and 601B. That is, the PID filter section 506 compares a PID value contained in the descrambled TS packet and each PID value set in the PID tables 601A and 601B with each other to determine whether or not the PID value contained in the descrambled TS packet coincides with any one of the PID values set in the PID tables 601A and 601B. When the coincidence is obtained, the PID filter section 506 feeds the descrambled TS packet to the encryption section 507.

Thus, it is possible to perform a PID filtering processing at a high speed by conducting the PID filtering processing referring to the PID tables 601A and 601B where the PID values have been set.

The encryption section 507 encrypts each TS packet fed from the PID filter section 506 to output the same to the PCI bus. Thereby, a partial transport stream including only the encrypted TS packet group regarding a broadcast program to be received is transferred to the main memory 103 via the PCI bus.

The TV application program is provided with a software decoder 701. The software decoder 701 is a program for causing the CPU 101 to perform reception and playback of the partial transport stream from the copyright protection LSI 203. The software decoder 701 is provided with a decoding section 711, a demultiplexer 712, a video decoder 713, and an audio decoder 714 as a function module.

The decoding section 711 decodes each TS packet included in the partial transport stream using the cryptographic key shared by the copyright protection LSI 203. The decoded partial transport stream is fed to the demultiplexer 712. The demultiplexer 712 separates the decoded partial transport stream to TS packets including video data and TS packets including audio data. Each of the TS packets including video data is fed to the video decoder 713, while each of the TS packets including audio data is fed to the audio decoder 714. The video decoder 713 decodes (expands) the video data. The decoded video data is displayed on the LCD 17. The audio decoder 714 decodes (expands) the audio data. The decoded audio data is outputted from the speakers 18A and 18B.

As described above, the software decoder 701 cannot process digital broadcasting data at once and it must process the same sequentially. Accordingly, after data processed at each module is once stored in the main memory 103, the data must be delivered to the next stage module. Since content of the data may be read or captured on an open system at a delivery time of the data, it is necessary to encrypt the data.

Therefore, partial decoding sections 711A and 712B for partially encrypting data are provided at output portions of the respective modules 711 and 712 and partial decoding sections 712A, 713A, and 714A are provided at input portions of respective modules 712, 713, and 714.

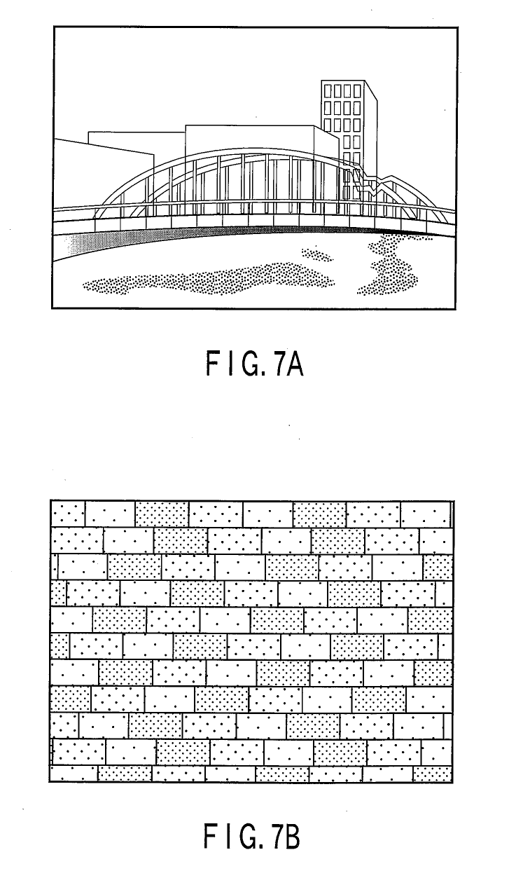

By inserting partial encrypting/decoding portions in an output portion and an input portion of each module, even if data is captured between modules, since the data has been partially encrypted, data cannot be played back as shown in FIG. 7. Incidentally, FIG. 7A is a video displayed on the LCD 17, and FIG. 7B is a video played back based upon the captured data.

Since an amount of data to be encrypted is 5% or less of a case where a whole stream is encrypted, a mount of data to be processed by the CPU is much reduced so that influence of performance degradation is reduced.

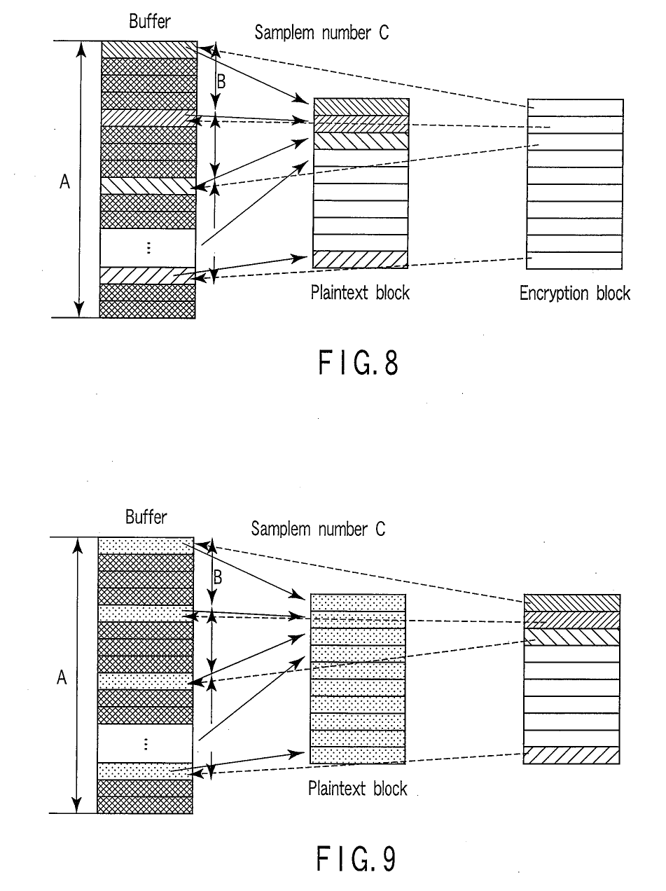

As shown in FIG. 8, when data is partially encrypted, a sample number C is taken out of a whole size A of a buffer in the CPU 101. In this case, an amount corresponding to D size for each offset of A/C=B is copied to a buffer before encryption. After all C samples are copied, a whole plaintext buffer before encryption is encrypted by an encryption system such as AES at once. Since the result of the encryption is outputted to a buffer after encryption, copying back to the original buffer is performed for each offset of A/C=B. After C samples are copied, the buffer is fed to the next stage module. Regarding how to take out the samples, the samples can be taken out for at the same interval as described above or they may be taken out at offset intervals of the same sequence such as hash.

As shown in FIG. 9, decoding conducted by the partial decoding sections 712A, 713A, and 714A is performed according to an inverse procedure. Since a size A of a buffer received by the latter stage module is the same as that at the decoding time, a position of a sample to be decoded is the same as that at the encrypting time. Accordingly, after copy to a buffer of an encryption block is performed for each offset of A/C=B and C samples are copied, decoding is performed using the same key as used at the encrypting time utilizing AES. The decoding is completed by performing copying-back of the samples to the buffer of TS for each offset of the same B from the buffer after decoding to return the samples. The samples are fed to the next stage module after decoding. Regarding how to take out the samples, the samples can be taken out for at the same interval as described above or they may be taken out at offset intervals of the same sequence such as hash.

In the abovementioned embodiment, in a case of a digital broadcasting receiver or a computer receiving digital broadcasting, decoding of broadcasting content may be performed using a CPU, but when decoding is performed using a hardware of a tuner section, decoded data is transferred to a memory via a universal bus such as a PCI bus. In order to prevent data during transfer from being captured, a system utilizing the abovementioned partial encryption can be used. Since processing amounts in hardware processing at an encrypting time and in decoding utilizing software after transfer are smaller than the processing amount in encryption processing to all data, cost of hardware and CPU utilization can be reduced.

The present invention can be applied to all devices handling video or audio content requiring protection such as copy limitation.

For example, video content is taken out of such a recording media as HD or DVD and decoding thereof is performed internally so that video is displayed back on a display section, but processing modules for softwares or hardwares in respective stages are required in order to decode video, and the present invention can be applied to a case that encryption in a memory between the respective stages is required.

In recoding into HDD, DVD or the like, it is possible to conduct recoding utilizing a partial encryption system instead of a whole encryption system.

When digital content is distributed via a network, the present invention can be used in a device transmitting the digital content to a network or in a set top box on a reception side.

Such a configuration can be adopted that, by encrypting only a portion of digital data, display and playback of content of a limited scene can be conducted but the other scene cannot be watched.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus which conducts display of video and output of audio from video and audio information including video data and audio data, comprising:
a processor configure to execute various softwares;
a memory configure to store data therein; and
a decoder configured from a software configured from a plurality of modules and executed by the processor in order to perform a processing for conducting display of video and output of audio, where the decoder causes the processor to perform a processing for partially encrypting data transferred between the modules via the memory and a processing for decoding the data transferred between the modules via the memory.

2. The information processing apparatus according to claim 1, wherein
in the processing for partially encrypting the data, the processor performs a processing for extracting a plurality of partial data from the data, a processing for encrypting the plurality of data extracted as one block, and a processing for dividing the encrypted block into pieces to replace the data extracted by the pieces, and
in the processing for decoding the partially encrypted produced data, the processor performs a processing for taking the replaced portion from data transferred from another module to recover the one block, a processing for decoding the partially encrypted data, and a processing for replacing the decoded data by the divided and extracted portion.

3. The information processing apparatus according to claim 2, wherein
at a time of the processing for extracting a plurality of partial data form the data, extracting manner is changed according to a certain rule.

4. The information processing apparatus according to claim 1, further comprising a tuner configured to receive digital broadcasting to output the video and audio information.

5. The information processing apparatus according to claim 1, further comprising an optical disk device for playing back an optical disk on which the video and audio information has been recorded.

6. A video and audio information protecting method, wherein, when video and audio information including video data and audio data and requiring content protection is transferred as a stream of a communication network, the video and audio information is partially encrypted.

7. The video and audio information protecting method according to claim 6, wherein
in the processing for partially encrypting the data, a processing for extracting a plurality of partial data from the video and audio information, and a processing for encrypting the plurality of data extracted as one block and dividing the encrypted block into pieces to replace the plurality of data extracted by the pieces are performed.

8. The video and audio information protecting method according to claim 7, wherein
when the plurality of partial data is extracted from the data, a method for extracting the plurality of partial data is changed according to a certain rule.
